(19) United States
(12) Patent Application Publication
(10) Pub. No.: US 2026/0214202 A1
(43) Pub. Date: Jul. 23, 2026

(54) IMAGING OBSTRUCTION DETECTION APPARATUS

(71) Applicant: JVCKENWOOD CORPORATION, Yokohama-shi (JP)

(72) Inventor: Kazuya HAKOISHI, Yokohama-shi (JP)

(21) Appl. No.: 19/569,361

(22) Filed: Mar. 17, 2026

Related U.S. Application Data
(63) Continuation of application No. PCT/JP2024/029517, filed on Aug. 20, 2024.

(30) Foreign Application Priority Data
Sep. 25, 2023 (JP) 2023-161656
Sep. 25, 2023 (JP) 2023-161768

(51) Int. Cl. H04N 17/00; H04N 7/18; H04N 23/67

(52) U.S. Cl. CPC H04N 17/002; H04N 23/67; H04N 7/183

(57) ABSTRACT

An imaging obstruction detection apparatus detects imaging obstruction of a camera and includes a detection unit. The detection unit outputs a detection signal indicating detection of an abnormality in an autofocus operation when sharpness in a captured image by the camera at a preset position changes by a predetermined amount or more from a reference sharpness and when a focus point after the autofocus operation of the camera shifts to a near side from a reference focus position at the preset position.

### CROSS-REFERENCE TO RELATED APPLICATIONS

The present application is a continuation of International Application No. PCT/JP 2024/029517 filed on Aug. 20, 2024, and based upon and claims the benefit of priority from Japanese Patent Applications No. 2023-161656 filed on Sep. 25, 2023, and No. 2023-161768 filed on Sep. 25, 2023, the entire contents of which are incorporated herein by reference.

### BACKGROUND

The disclosure relates to an imaging obstruction detection apparatus.

Patent Literature 1 (JP 2008-77517 A) proposes a technology that calculates a luminance difference between an image from a surveillance camera and a reference image for each pixel, and determines whether there is a camera obstruction based on the number of changed pixels each in which the luminance difference is greater than a first threshold value.

### SUMMARY

An imaging obstruction detection apparatus according to the embodiments, detects imaging obstruction of a camera, and includes: a detection unit configured to output a detection signal indicating detection of an abnormality in an autofocus operation when sharpness in a captured image by the camera at a preset position changes by a predetermined amount or more from a reference sharpness and when a focus point after the autofocus operation of the camera shifts to a near side from a reference focus position at the preset position.

An imaging obstruction detection method according to the embodiments, in an imaging obstruction detection apparatus that detects imaging obstruction of a camera, includes: outputting a detection signal indicating detection of an abnormality in an autofocus operation when sharpness in a captured image by the camera at a preset position changes by a predetermined amount or more from a reference sharpness and when a focus point after the autofocus operation of the camera shifts to a near side from a reference focus position at the preset position.

### BRIEF DESCRIPTION OF DRAWINGS

FIG. 1 is a diagram illustrating an outline of a configuration of a surveillance camera apparatus provided with an imaging obstruction detection apparatus according to a first embodiment.

FIG. 2 is a diagram illustrating an example of settings of preset positions by a camera unit illustrated in FIG. 1.

FIG. 3 is a diagram showing imaging information registered for the preset positions illustrated in FIG. 2.

FIG. 4 is a flowchart showing an example of a processing procedure to be executed in the imaging obstruction detection apparatus illustrated in FIG. 1.

FIG. 5 is a diagram showing an example of each relationship between a pattern of imaging obstruction to be assumed in the surveillance camera apparatus illustrated in FIG. 1 and an event occurring in the pattern.

FIG. 6 is a diagram illustrating an example of a state in which one of the preset positions illustrated in FIG. 2 is blocked from the field of view of a lens block by an obstruction.

FIG. 7 is a flowchart showing an example of a processing procedure to be executed in the imaging obstruction detection apparatus according to a second embodiment.

FIG. 8 is a flowchart showing an example of a processing procedure to be executed in the imaging obstruction detection apparatus according to a third embodiment.

FIG. 9 is a flowchart showing an example of a processing procedure to be executed in the imaging obstruction detection apparatus according to a fourth embodiment.

### DETAILED DESCRIPTION

Hereinafter, the first to fourth embodiments will be described with reference to the drawings. Throughout the drawings, the same or equivalent parts or components are denoted by the same reference numerals.

The embodiments to be described below exemplify apparatuses and the like for embodying the technical idea of the disclosure. The technical idea of the disclosure does not specify a material, a shape, a structure, an arrangements, and the like of each component to those to be described below.

### First Embodiment

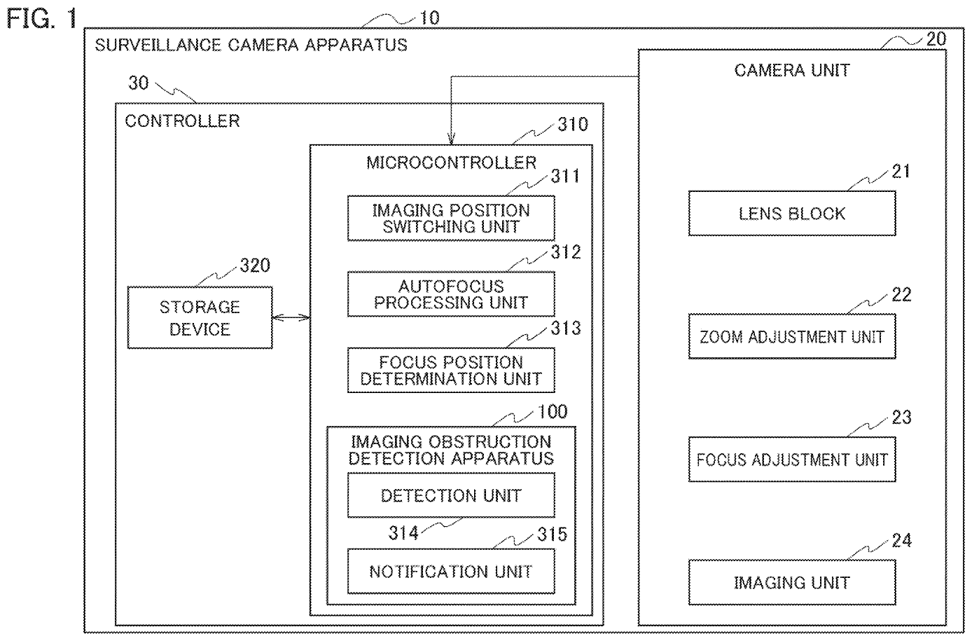

The present embodiment is an embodiment for detecting imaging obstruction using changes in sharpness. As illustrated in FIG. 1, an imaging obstruction detection apparatus 100 of the first embodiment is provided in a surveillance camera apparatus 10 that outputs captured images of a monitored space (not illustrated). The surveillance camera apparatus 10 includes a camera unit 20 and a controller 30. The imaging obstruction detection apparatus 100 can be configured using the controller 30, for example.

The camera unit 20 is installed at a high position in the monitored space, for example. The high position may be a ceiling of the monitored space, for example. The camera unit 20 may be a PTZ (Pan-Tilt-Zoom) camera having built-in tilt and pan mechanisms (both not illustrated) that change an imaging direction up, down, left, and right, for example. The camera unit 20 has a lens block 21, a zoom adjustment unit 22, a focus adjustment unit 23, and an imaging unit 24.

The lens block 21 has a lens group consisting of a plurality of lenses. Each of the lenses constituting the lens group can move in its lens optical axis direction. The zoom adjustment unit 22 and the focus adjustment unit 23 individually move each of the lenses of the lens group in the lens optical axis direction to optically adjust a zoom position of the lens block 21 and a focus position of the lens block 21 corresponding to a magnification of a subject image, respectively.

The imaging unit 24 is an image sensor having a solid-state imaging element. CMOS (Complementary Metal-Oxide-Semiconductor) or CCD (Charge-Coupled Device) can be used as the solid-state imaging element, for example. An image is formed on the imaging unit 24 by light that has passed through the lens block 21. The imaging unit 24 photoelectrically converts the light of the image formed on the imaging unit 24 and outputs an image signal that is an electrical signal of the image formed on the imaging unit 24.

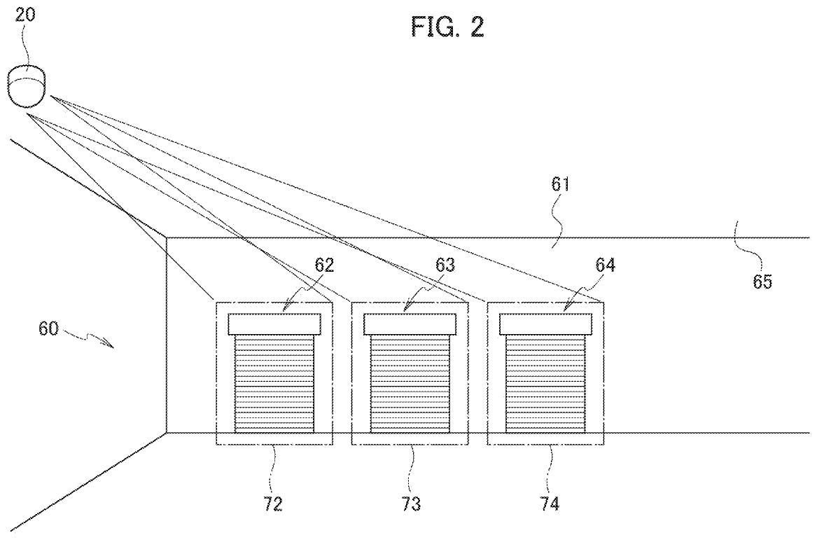

The camera unit 20 can perform patrol imaging that sequentially switches an imaging position among a plurality of preset positions. In addition to the patrol imaging, the camera unit 20 can capture images at any position desired by a user, for example, by a user who operates a control panel (not illustrated). If an original imaging position was registered as a preset position, the imaging position of the camera unit 20 can be returned to the original position after an arbitrary position is captured with the camera unit 20 by a user operation. The preset position of the camera unit 20 can be registered in advance. FIG. 2 illustrates a case where conditions for capturing three gates 62 to 64 provided on a wall 61 of a distribution warehouse 60, which is the monitored space, are set as preset positions 72 to 74. In this example, the camera unit 20 is installed on a ceiling 65 of the distribution warehouse 60.

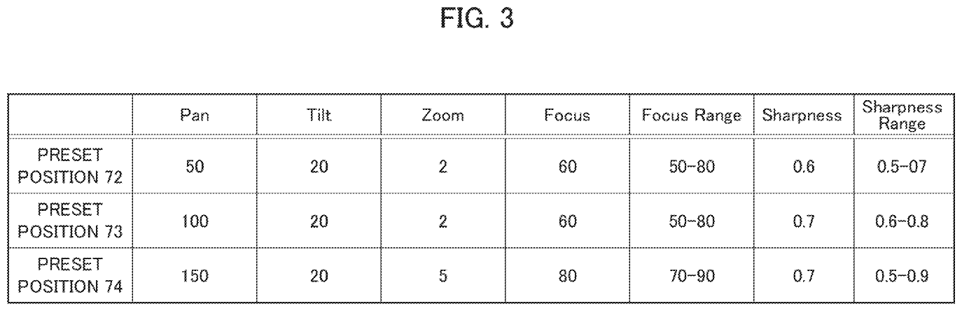

FIG. 3 shows imaging information by the camera unit 20 that is registered in advance for each of the preset positions 72 to 74. That is, a preset position is an imaging condition, and as an example of imaging information, a combination of parameters “Pan”, “Tilt”, “Zoom”, “Focus”, “Focus Range”, “Sharpness” and “Sharpness Range” is registered, and a plurality of preset positions can be stored in a storage device 320. For example, when the camera unit 20 is a PTZ camera, the parameters “Pan,” “Tilt,” and “Zoom” are registered in the storage device 320 as imaging information for preset positions 72 to 74.

The parameter “Pan” is a swing angle of the camera unit 20 in a left-right direction from a reference direction (not shown), and the parameter “Tilt” is a swing angle of the camera unit 20 in an up-down direction from the reference direction, and a unit for both is degrees. The parameter “Zoom” is an optical zoom magnification of a subject by the lens block 21.

The parameter “Focus” is initially set to each of the preset positions 72 to 74 in which the parameters “Pan,” “Tilt,” and “Zoom” have been registered as imaging information. The parameter “Focus” is a distance from a principal point to a focus point of the lens block 21, and a unit for it is millimeters (mm). When the lens block 21 is replaced with an optically equivalent single lens, the principal point of the lens block 21 is a center point of the lens. In an initial setting of the parameter “Focus”, the camera unit 20 captures each of the preset positions 72 to 74 with the registered parameters “Pan,” “Tilt,” and “Zoom,” and performs an autofocus operation. When each of the preset positions 72 to 74 is captured in a state of FIG. 2 in order to set the parameter “Focus”, the lens block 21 focuses on each of the gates 62 to 64 by the autofocus operation performed by the camera unit 20. A focus of the lens block 21 at this time is an initially set value in the imaging information of each of the preset positions 72 to 74, that is, a reference focus position, and is registered in the storage device 320 as the parameter “Focus” together with the parameters “Pan,” “Tilt,” and “Zoom.” The registered reference focus position (“Focus”) of each of the preset positions 72 to 74 can be used for detecting imaging obstruction of the surveillance camera apparatus 10, for example. Imaging obstruction of the surveillance camera apparatus 10 can be detected based on whether the focus of the lens block 21 at the time of capturing each of the preset positions 72 to 74 is changed from the reference focus position, for example. Whether the focus of the lens block 21 is changed from the reference focus position can be determined by comparing the focus of the lens block 21 after the autofocus operation with the parameter “Focus,” that is, the reference focus position, at the time of capturing each of the preset positions 72 to 74. The focus position is also called a focal position.

In the example shown in FIG. 3, the parameter “Focus Range” is added to the imaging information of each of the preset positions 72 to 74. Even if an imaging target by the camera unit 20 does not change, the focus of the lens block 21 may shift slightly due to a vibration of the camera unit 20 or a change in an imaging condition such as lighting, for example. The parameter “Focus Range” indicates an allowable range of a deviation of the focus of the lens block 21 from the reference focus position when determining whether the focus of the lens block 21 at the time of capturing each of the preset positions 72 to 74 is changed from the reference focus position. For example, if the focus of the lens block 21 at the time of capturing is within the range indicated by the parameter “Focus Range,” it can be determined that the focus of the lens block 21 at the time of capturing is not changed from the parameter “Focus,” that is, the reference focus position. A unit of the parameter “Focus Range” is millimeters (mm). For example, if a focus change when the camera unit 20 focuses on an incoming/outgoing vehicle (not illustrated) passing through the gates 62 to 64 is not to be considered imaging obstruction, the parameter “Focus Range” may be set to a wide range. By setting the parameter “Focus Range” to the wide range, even if the focus of the lens block 21 at the time of capturing each of the preset positions 72 to 74 shifts to a position of the incoming/outgoing vehicle, for example, it can be configured not to be determined as a deviation corresponding to imaging obstruction. As shown in FIG. 3, in the preset position 74, the parameter “Focus,” that is, the reference focus position is 80 (mm). For example, if the focus of the lens block 21 at the time of capturing changes to 70 (mm) due to an incoming/outgoing vehicle at the gate 64, since 70 (mm) is within the range of the parameter “Focus Range,” it is not determined that the focus of the lens block 21 at the time of capturing is changed from the reference focus position. If the parameter “Focus Range” is set to a range that does not include a focus when, for example, a cloth is placed over the camera unit 20, the change in the focus of the lens block 21 at the time of capturing due to the cloth being placed can be determined as a change from the reference focus position, and imaging obstruction can be detected.

As illustrated in FIG. 1, the controller 30 has a general-purpose microcontroller 310 and the storage device 320. The storage device 320 can be configured by an SSD (Solid State Drive) or an HDD (Hard Disk Drive), for example. The microcontroller 310 includes a CPU (Central Processing Unit) and a memory. The memory includes a ROM (Read Only Memory) and a RAM (Random Access Memory). The microcontroller 310 can virtually configure a plurality of information processing circuits by the CPU executing a program(s) stored in the memory, for example. The plurality of information processing circuits can constitute an input and output unit and an arithmetic unit of the microcontroller 310.

The input and output unit can acquire an image signal output by the imaging unit 24, for example. The input and output unit can output the image signal when the camera unit 20 captures an imaging position including each of the preset positions 72 to 74, to a display (not illustrated), for example. The arithmetic unit can include an imaging position switching unit 311, an autofocus processing unit 312, a focus position determination unit 313, a detection unit 314, and a notification unit 315 of the microcontroller 310, which will be described later. The imaging obstruction detection apparatus 100 of the first embodiment can be configured to include a detection unit 314, and may further include a notification unit 315.

In the present embodiment, an example is shown in which the plurality of information processing circuits configured in the microcontroller 310 are realized by software. Of course, it is also possible to configure the information processing circuits by preparing dedicated hardware for executing each information processing of the input and output unit and the arithmetic unit. Also, the plurality of information processing circuits may be configured by individual hardware. The dedicated hardware includes devices such as application specific integrated circuits (ASIC) arranged to execute functions of the input and output unit and the arithmetic unit, and conventional circuit components.

The imaging position switching unit 311 switches the imaging position of the camera unit 20. When the patrol imaging is performed with the camera unit 20, the imaging position switching unit 311 sequentially switches orientations and zoom magnifications of the camera unit 20, each orientation and zoom magnification corresponding to the parameters “Pan,” “Tilt,” and “Zoom” of each of the preset positions 72 to 74 stored in the storage device 320. When capturing an arbitrary position desired by a user with the camera unit 20, the imaging position switching unit 311 switches an orientation and a zoom magnification of the camera unit 20 corresponding to the user's operation. Switching of the imaging position can be performed by operating the tilt and pan mechanisms (not illustrated) of the camera unit 20 and the zoom adjustment unit 22. When the patrol imaging is performed, the imaging position can be switched at regular intervals, for example.

The autofocus processing unit 312 executes the autofocus operation of the camera unit 20 when the imaging position of the camera unit 20 is switched by the patrol imaging or the user operation, for example. The autofocus processing unit 312 executes the autofocus operation of the camera unit 20 even at times other than when the imaging position of the camera unit 20 is switched, for example, when the autofocus processing unit 312 is instructed by the detection unit 314 to be described later. The case where the autofocus processing unit 312 is instructed to execute the autofocus operation by the detection unit 314 will be described later.

The autofocus processing unit 312 may perform contrast autofocus processing that is performed by image processing, or may perform phase difference autofocus processing that does not require image processing.

In the contrast autofocus processing, the autofocus processing unit 312 individually moves the respective lenses in the lens group of the lens block 21 in the corresponding lens optical axis directions by the zoom adjustment unit 22 and the focus adjustment unit 23. While moving the respective lenses of the lens block 21, the autofocus processing unit 312 calculates the sharpness (contrast) of the image signal input from the imaging unit 24 and then searches for a position where the calculated sharpness increases. The sharpness of an image is a physical quantity related to clarity and sharpness of the image, and is also called sharpness. For example, clarity of a rise at a boundary between white and black in an image, and distinctness of a perspective in an image, are related to the sharpness of the image. The sharpness of an image can be calculated using a transfer function (Modulated Transfer Function) of the lens block 21, for example. The transfer function (MTF) of the lens block 21 can be measured from a captured image by the camera unit 20 that has captured a sine wave chart in which light transmittance changes in a sine curve from 100% to 0%, for example. The sharpness of an image decreases as the blur of the image increases. The blur of an image becomes more pronounced as the deviation of the focus of the lens block 21 from the position of the subject increases.

In the contrast autofocus processing, the autofocus processing unit 312 stops the movement of each lens at a position where the sharpness of the image signal is maximum, and then completes the autofocus operation of the camera unit 20. The focus of the lens block 21 when the autofocus operation is completed is at a position of an imaging target that is in focus in capturing at the imaging position, or at a position near the imaging target.

In the phase difference autofocus processing, the autofocus processing unit 312 detects a phase difference between two images formed on the imaging unit 24 by light that has passed through the lens block 21. The two images used for detecting the phase difference may be two images formed on separate imaging elements of the imaging unit 24 by bifurcating the light that has passed through the lens block 21 into two by a beam splitter. The two images used for detecting the phase difference may be two images each formed on an AF (Auto Focus) sensor arranged on a single imaging element of the imaging unit 24 by dividing the light that has passed through the lens block 21 into two by a separator lens (not illustrated). In the latter case, the phase difference between the two images is an image plane phase difference obtained from an output of the AF sensor. The autofocus processing unit 312 detects pixel shift of the two images based on the detected phase difference, and detects a shift amount and a shift direction of the focus of the lens block 21 from the detected pixel shift. The autofocus processing unit 312 executes the autofocus operation of the camera unit 20 based on the detected shift amount of the focus.

The autofocus processing unit 312 normally terminates the autofocus operation when the autofocus operation is completed within a predetermined time from a start of the autofocus operation. If the autofocus operation is not completed within the predetermined time from the start, the autofocus processing unit 312 abnormally terminates the autofocus operation.

The focus position determination unit 313 determines the focus position of the lens block 21 when the autofocus operation is normally terminated, from a movement amount of each lens of the lens block 21. The focus position determination unit 313 may store the determined focus position of the lens block 21 as the focus position after the autofocus operation in the memory of the microcontroller 310, for example. The focus position determination unit 313 can determine whether the determined focus of the lens block 21 is deviated from the reference focus position at each of the preset positions 72 to 74, which are the imaging positions during the autofocus operation, to either near or far.

During operation of the imaging obstruction detection apparatus 100, the sharpness of the captured image by the camera unit 20 is calculated to detect imaging obstruction of the camera unit 20. The sharpness of the captured image by the camera unit 20 can be calculated from the image signal input from the imaging unit 24. The sharpness of the captured image may be constantly calculated during operation of the imaging obstruction detection apparatus 100, or may be calculated each time a position to be captured by the camera unit 20 is changed. The autofocus processing unit 312 that performs contrast autofocus processing can divert the sharpness of the captured image calculated for the autofocus operation to detect imaging obstruction of the camera unit 20. In this case, it is not necessary to perform new image processing for obstruction detection, which simplifies a processing procedure and eliminates a need to provide a new image processing block. When the autofocus processing unit 312 does not calculate sharpness, the detection unit 314 may calculate the sharpness of the captured image.

The detection unit 314 compares the sharpness of the captured image by the camera unit 20 with a predetermined reference sharpness. When the autofocus processing unit 312 calculates the sharpness, the detection unit 314 compares the sharpness acquired from the autofocus processing unit 312 with the reference sharpness. The reference sharpness may be determined as a uniform single value regardless of the imaging position of the camera unit 20, or may be determined as an individual value for each of the preset positions 72 to 74, for example. In the latter case, the sharpness calculated by the autofocus processing unit 312 with the lens block 21 in focus on each of the gates 62 to 64 corresponding to the preset positions 72 to 74, can be registered as the reference sharpness of each of the preset positions 72 to 74, for example. In the storage device 320 in which the parameters of the imaging information of the preset positions 72 to 74 are registered, the parameter “Sharpness” is initially set as the reference sharpness as shown in FIG. 3, for example. The initially set parameter “Sharpness” can be a value of the sharpness of the captured image by the camera unit 20 calculated by the autofocus processing unit 312 or the detection unit 314 with the lens block 21 in focus on each of the gates 62 to 64. As in the example shown in FIG. 3, the parameter “Sharpness Range” may be added to the imaging information of preset positions 72 to 74. There is a case where the sharpness of the captured image shifts slightly due to vibration of the camera unit 20 or a change in an imaging condition such as lighting, for example. The parameter “Sharpness Range” indicates an allowable range of deviation from the initially set value of the parameter “Sharpness”. The reference sharpness may be stored in the storage device 320, for example.

The detection unit 314 outputs a first detection signal to instruct the autofocus processing unit 312 to execute the autofocus operation when a predetermined change with respect to the reference sharpness occurs in the calculated sharpness of the captured image by the camera unit 20. The first detection signal is a signal indicating that it is detected that a predetermined sharpness change with respect to the reference sharpness occurs in one of the captured images of the preset positions 72 to 74 captured by the camera unit 20. The predetermined change with respect to the reference sharpness includes a case where the calculated sharpness decreases by a predetermined amount or more from the reference sharpness, and a case where the calculated sharpness changes beyond the allowable range of the reference sharpness. These cases may include a case where the sharpness of the captured image at the preset position changes by a predetermined amount or more from the predetermined reference sharpness of the preset position. For example, when the focus of the lens block 21 deviates by a certain distance or more from the in-focus position, the calculated sharpness decreases by a predetermined amount or more from the reference sharpness. The change in sharpness that exceeds the allowable range of the reference sharpness includes not only a case where the sharpness decreases beyond a lower limit value of the allowable range, but also a case where the sharpness increases beyond an upper limit value of the allowable range. Since an increase in sharpness occurs when the focus of the lens block 21 approaches the in-focus position, it is basically not necessary to regard it as a problem. However, an extreme increase in sharpness that exceeds the upper limit value of the allowable range may also occur due to factors other than the focus of the lens block 21 approaching the in-focus position. The detection unit 314 can also detect a case where the sharpness becomes extremely high for some reason as a subject of predetermined change with respect to the reference sharpness.

The reference sharpness may be a uniform single value regardless of the imaging position of the camera unit 20, for example. When the imaging position of the camera unit 20 is each of the preset positions 72 to 74, the reference sharpness may be determined for each of the preset positions 72 to 74. When the reference sharpness is determined for each of the preset positions 72 to 74, the detection unit 314 may detect that a predetermined change with respect to the reference sharpness of each of the preset positions 72 to 74 corresponding to the imaging position occurs in the sharpness of the captured image.

After the autofocus processing unit 312 executes the autofocus operation according to the instruction from the detection unit 314, the focus position determination unit 313 determines whether the focus of the lens block 21 deviates from the reference focus position at each of the preset positions 72 to 74, which is the imaging position. The focus position determination unit 313 may determine whether the focus of the lens block 21 after the autofocus operation deviates from the reference focus position using the upper limit value and the lower limit value of the parameter “Focus Range” of each of the preset positions 72 to 74 in FIG. 3 as threshold values. The detection unit 314 outputs a second detection signal when the focus position determination unit 313 determines that the focus of the lens block 21 after the autofocus operation deviates from the reference focus position. The second detection signal is a signal indicating detection of an abnormality in the autofocus operation. For example, when the imaging position at the time of outputting the first detection signal and the second detection signal is the preset position 72, the first detection signal and the second detection signal output by the detection unit 314 are detection signals related to the preset position 72.

The detection unit 314 may be configured to output the second detection signal only when the focus position determination unit 313 determines that the focus of the lens block 21 after the autofocus operation deviates to a near side closer to the camera unit 20 than the reference focus position, for example. A focus length of the lens block 21 whose focus deviates to the near side from the reference focus position after the autofocus operation at each of the preset positions 72 to 74, is in a state shorter than the lower limit value of the parameter “Focus Range” of each of the preset positions 72 to 74. The detection unit 314 regards this state as a state in which an obstruction that obstructs the imaging of each of the gates 62 to 64 appears between each of the gates 62 to 64, which should originally be captured when capturing each of the preset positions 72 to 74, and the camera unit 20. The position deviating to the near side from the reference focus position may be determined, for example, by whether the focus is at a position closer to the camera unit 20 than an adjustable range of the focus corresponding to the registered parameter “Zoom” of each of the preset positions 72 to 74 that is the imaging position. If the focus of the lens block 21 is within the adjustable range, it can be considered that the focus is substantially at a position within the range of the parameter “Focus Range” of each of the preset positions 72 to 74 that is the imaging position.

The detection unit 314 may be configured to output a different detection signal for each of cases: when the focus of the lens block 21 after the autofocus operation deviates from the reference focus position, when the focus deviates to the near side from the reference focus position, and when the autofocus operation is terminated abnormally.

The detection state of sharpness decreases in which the detection unit 314 outputs the first detection signal, and the detection state of abnormality in the autofocus operation in which the detection unit 314 outputs the second detection signal, can be considered to occur due to obstruction of imaging by the camera unit 20. The notification unit 315 outputs a notification signal that notifies a user of a state in which imaging by the camera unit 20 at each of the preset positions 72 to 74 is obstructed, based on the first detection signal or the second detection signal output by the detection unit 314.

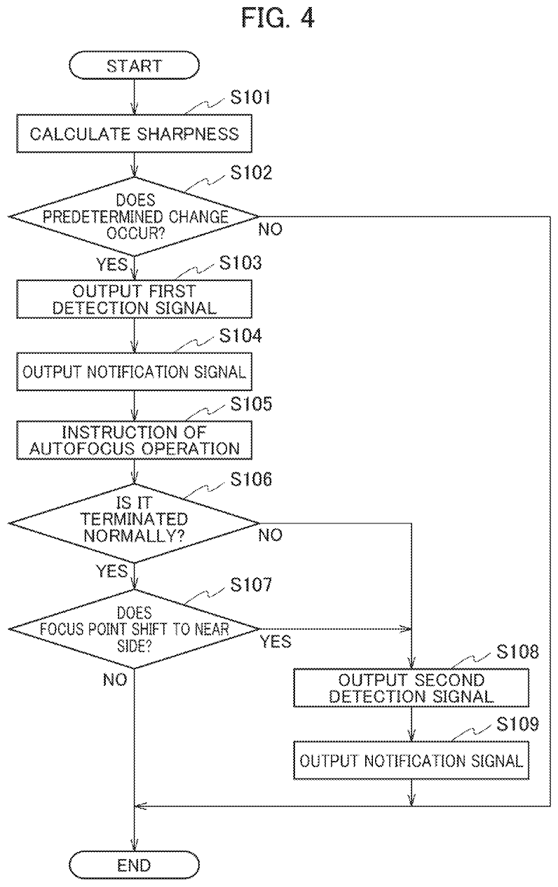

Next, an example of a processing procedure to be executed in the imaging obstruction detection apparatus 100 to detect a state in which imaging by the camera unit 20 is obstructed in the surveillance camera apparatus 10 of the present embodiment will be described with reference to FIG. 4. The imaging obstruction detection apparatus 100 repeatedly executes the processing procedure shown in FIG. 4 during operation of the surveillance camera apparatus 10. First, the autofocus processing unit 312 or the detection unit 314 calculates sharpness of an image in an image signal input from the imaging unit 24 (step S101). The detection unit 314 confirms whether a predetermined change with respect to the reference sharpness occurs in the calculated sharpness (step S102). In the present embodiment, a uniform reference sharpness regardless of the imaging position of the camera unit 20 is used to confirm whether a predetermined change occurs in the calculated sharpness.

If the predetermined change with respect to the reference sharpness does not occur in the calculated sharpness (NO in step S102), the series of steps is terminated. If the predetermined change with respect to the reference sharpness occurs in the calculated sharpness (YES in step S102), the detection unit 314 outputs the first detection signal indicating detection of the predetermined change with respect to the reference sharpness (step S103). Based on the first detection signal output by the detection unit 314, the notification unit 315 outputs the notification signal (step S104). The notification signal may have a content that notifies that imaging obstruction is detected based on sharpness, for example. After the notification unit 315 outputs the notification signal, the process proceeds to step S105.

In step S105, the detection unit 314 instructs the autofocus processing unit 312 to execute the autofocus operation of the camera unit 20. The detection unit 314 confirms whether the autofocus operation executed by the autofocus processing unit 312 is terminated normally (step S106). If the autofocus operation is not terminated normally and is terminated abnormally (NO in step S106), the process proceeds to step S108, which will be described later. If the autofocus operation is terminated normally (YES in step S106), the detection unit 314 confirms whether the focus point of the lens block 21 determined by the focus position determination unit 313 after the autofocus operation shifts to the near side (step S107). The detection unit 314 confirms whether the focus point of the lens block 21 after the autofocus operation shifts to the near side based on the reference focus position at one of the preset positions 72 to 74 corresponding to the imaging position of the camera unit 20.

The detection unit 314 may confirm that the focus point shifts to the near side from the reference focus position when the focus length of the lens block 21 after the autofocus operation is shorter than the lower limit value of the registered parameter “Focus Range” of the one of the preset positions 72 to 74 at the imaging position, for example. The detection unit 314 may confirm that the focus point shifts to the near side from the reference focus position when the focus length of the lens block 21 is shorter than the lower limit value of the adjustable range of the focus point corresponding to the registered parameter “Zoom” of the one of the preset positions 72 to 74 at the imaging position.

If the focus point of the lens block 21 after the autofocus operation does not shift to the near side from the reference focus position (NO in step S107), the series of steps is terminated. If the focus point after the autofocus operation shifts to the near side from the reference focus position (YES in step S107), the process proceeds to step S108.

In step S108, the detection unit 314 outputs a second detection signal indicating detection of an abnormality in the autofocus operation. The notification unit 315 outputs the notification signal based on the second detection signal output by the detection unit 314 (step S109). The notification signal may have a content that notifies that imaging obstruction is detected based on the focus position of the lens block 21 after the autofocus operation of the camera unit 20 and the presence or absence of abnormal termination of the autofocus operation, for example. After the notification unit 315 outputs the notification signal, the series of steps is terminated.

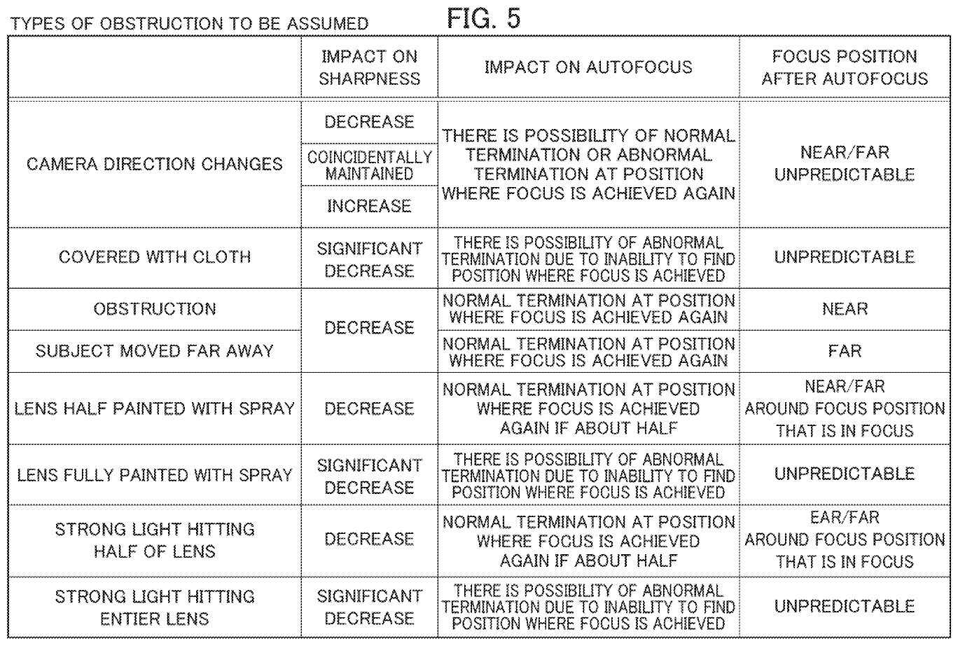

FIG. 5 shows an example of each relationship between a pattern of imaging obstruction to be assumed in the surveillance camera apparatus 10 and an event occurring in the pattern. As scenes each in which imaging at each of the preset positions 72 to 74 is obstructed in the surveillance camera apparatus 10, scenes as shown in the leftmost column of FIG. 5 can be mentioned, for example.

Here, regarding sharpness of an image in an image signal captured by the camera unit 20, in each of the scenes “obstruction”, “lens half painted with spray”, and “strong light hitting half of lens”, occurrence of sharpness change in the image is assumed. The assumed sharpness change is, for example, that the sharpness of the image decreases from the reference sharpness as shown in the second column from the left in FIG. 5. In each of the scenes “covered with cloth”, “lens fully painted with spray”, and “strong light hitting entire lens”, it is assumed that the sharpness of the image significantly decreases from the reference sharpness. In the scene “camera direction changes” depending on the difference in conditions before and after the direction change, it is assumed that the sharpness of the image decreases from the reference sharpness, increases from the reference sharpness, or coincidentally remains unchanged at the reference sharpness.

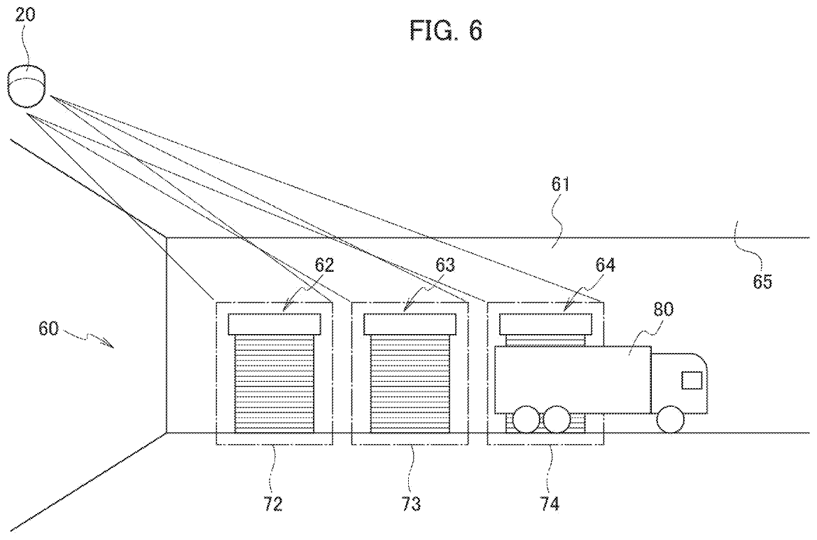

The scene “obstruction” means an object that exists between the reference focus position at each of the preset positions 72 to 74 and the camera unit 20 and blocks the field of view of the lens block 21 in front of the reference focus position. FIG. 6 illustrates a state in which a part of the gate 64 is blocked from a viewing range of the lens block 21 by a vehicle 80 in the distribution warehouse 60 when the imaging position is the preset position 74. In this case, the vehicle 80 corresponds to an “obstruction” that obstructs imaging of the gate 64 by the camera unit 20.

When imaging of each of imaging targets such as the gates 62 to 64 at the preset positions 72 to 74 is obstructed, in most scenes, as shown in FIG. 5, a decrease in the sharpness of the image in the image signal captured by the camera unit 20 is assumed. In the present embodiment, during operation of the imaging obstruction detection apparatus 100, the sharpness of the captured image by the camera unit 20 is calculated, and when the calculated sharpness decreases by a predetermined amount or more from the reference sharpness, the detection unit 314 and the notification unit 315 output the first detection signal and the notification signal of imaging obstruction, respectively. With the first detection signal, the imaging obstruction detection apparatus 100 can recognize in control, an occurrence of a sharpness change that leads to an occurrence of imaging obstruction, rather than merely a contrast change in the captured image by the camera unit 20. With the notification signal output based on the first detection signal, the imaging obstruction detection apparatus 100 can notify a user of the occurrence of imaging obstruction detected based on sharpness.

If a value decreased by a predetermined amount from the reference sharpness is set, for example, to a boundary value between a case where the sharpness “significantly decreases” and a case where the sharpness “decreases” in FIG. 5, an occurrence of a scene of imaging obstruction in which the sharpness of the image significantly decreases can be detected by comparison with the calculated sharpness. If a value decreased by a predetermined amount from the reference sharpness is set, for example, to a boundary value between a case where the sharpness “decreases” and a case where it is “coincidentally maintained” in FIG. 5, an occurrence of a scene of imaging obstruction in which the sharpness of the image decreases or significantly decreases can be detected by comparison with the calculated sharpness.

When detecting a predetermined change in the sharpness of the captured image with respect to the reference sharpness, for example, a decrease by a predetermined amount or more with respect to the reference sharpness, a scene in which merely a change in luminance difference of the captured image not caused by the occurrence of imaging obstruction occurs, is not detected. Compared to detecting the occurrence of imaging obstruction by changes in luminance difference of the captured image, erroneous detection of a scene in which imaging obstruction does not occur as a scene of imaging obstruction is suppressed. By detecting a sharpness change that leads to the occurrence of imaging obstruction, more accurate detection of obstruction of imaging at each of the preset positions 72 to 74 by the camera unit 20 can be achieved.

In the present embodiment, when the calculated sharpness decreases by a predetermined amount or more from the reference sharpness and when the detection unit 314 and the notification unit 315 respectively output the first detection signal and the notification signal, the autofocus operation of the camera unit 20 is performed. After the autofocus operation, it is confirmed whether the focus point of the lens block 21 moves from the reference focus position corresponding to each of the preset positions 72 to 74 at the start of the autofocus operation.

Regarding the focus point of the lens block 21 after the autofocus operation, in the scene “obstruction”, the focus point of the lens block 21 is on the near side from the reference focus position as shown in the rightmost column of FIG. 5. The near side means the camera unit 20 side from the reference focus position. In a scene “subject moved far away”, the focus point of the lens block 21 after the autofocus operation is on the far side from the reference focus position. The far side means a side opposite to the camera unit 20 side from the reference focus position.

In each of the scenes “lens half painted with spray” and “strong light hitting half of lens”, the focus point of the lens block 21 after the autofocus operation is on the near side or the far side from the reference focus position at each of the preset positions 72 to 74. In the scene “camera direction changes”, the focus point of the lens block 21 after the autofocus operation is on the near side or the far side from the reference focus position at each of the preset positions 72 to 74. Alternatively, the autofocus operation may terminate abnormally because a focusable imaging target cannot be identified, and the focus point of the lens block 21 after the autofocus operation may become unpredictable. In each of the scenes “covered with cloth”, “lens fully painted with spray” and “strong light hitting entire lens”, the autofocus operation may terminate abnormally, and the focus point of the lens block 21 after the autofocus operation may become unpredictable.

When the focus point of the lens block 21 moves to the camera unit 20 side from the registered reference focus position in the autofocus operation, the focus point of the lens block 21 is focused on an object positioned in front of each of the preset positions 72 to 74 as seen from the camera unit 20. In this case, it is assumed that a state exists in which an “obstruction” exists at a position on the camera unit 20 side from each of the preset positions 72 to 74. When the autofocus operation does not terminate normally in the autofocus operation, it is estimated that the camera unit 20 is in a state in which it cannot capture an imaging target that can be focused. In the state, it is considered that the field of view of the camera unit 20 is blocked in front of the imaging target or near the lens block 21.

When the focus point of the lens block 21 moves to a position deviated to the near side from the reference focus position in the autofocus operation, or when the autofocus operation does not terminate normally, the detection unit 314 and the notification unit 315 output the second detection signal and the notification signal, respectively. With the second detection signal, the imaging obstruction detection apparatus 100 can recognize in control an occurrence of an abnormality in the autofocus operation that leads to the occurrence of imaging obstruction. The abnormality in the autofocus operation includes a deviation of the focus point of the lens block 21 and an abnormal termination of the autofocus operation. The abnormality in the autofocus operation can be detected based on the focus point of the lens block 21. With the notification signal output based on the second detection signal, the imaging obstruction detection apparatus 100 can notify a user of the occurrence of imaging obstruction detected based on the focus point of the lens block 21. In the imaging obstruction detection apparatus 100 of the first embodiment, after outputting the notification signal based on the first detection signal indicating a decrease in sharpness of the captured image, when an abnormality in the autofocus operation is detected, the notification signal based on the second detection signal indicating the abnormality is output. By outputting both the notification signal associated with the decrease in sharpness of the captured image and the notification signal associated with the abnormality in the autofocus operation, the occurrence of imaging obstruction can be notified to a user with higher accuracy by the notification signal.

### First Modified Example of First Embodiment

In the imaging obstruction detection apparatus 100 of the first embodiment, the detection unit 314 confirmed whether the focus point of the lens block 21 after the autofocus operation shifts to the near side from the reference focus position in step S107. In the imaging obstruction detection apparatus 100 of the first modified example, the detection unit 314 confirms whether the focus point of the lens block 21 after the autofocus operation shifts from the reference focus position regardless of whether the focus point is the near side or the far side in step S107. When confirming the presence or absence of a focus shift regardless of a direction, if the focus point does not shift from the reference focus position (NO in step S107), the series of steps is terminated. If the focus point shifts from the reference focus position (YES in step S107), the process proceeds to step S108. In the present modified example, even when the focus point of the lens block 21 after the autofocus operation shifts to the far side from the reference focus position, an occurrence of an abnormality in the autofocus operation that leads to the occurrence of imaging obstruction can be recognized in control by the second detection signal.

### Second Modified Example of First Embodiment

In the imaging obstruction detection apparatus 100 of the first embodiment and the first modified example, after outputting the first detection signal indicating a decrease in sharpness of the captured image by the camera unit 20 and the notification signal of imaging obstruction based on the sharpness, the autofocus operation is performed. In this autofocus operation, when the focus point of the lens block 21 shifts from the reference focus position, or when the autofocus operation terminates abnormally, the second detection signal indicating an abnormality detection of the autofocus operation and the notification signal based on the focus point of the lens block 21 are output. However, the output of the notification signal (step S104 in FIG. 4) after the output of the first detection signal (step S103 in FIG. 4) may be omitted. In the present modified example in which the output of the notification signal based on the first detection signal is omitted, when a predetermined change in sharpness occurs (YES in step S102 of FIG. 4), the detection unit 314 outputs the first detection signal (step S103 of FIG. 4). After outputting the first detection signal, the detection unit 314 instructs execution of the autofocus operation (step S105 of FIG. 4). The detection unit 314 and the notification unit 315 execute the procedures (steps S106 to S109 of FIG. 4) after a confirmation of a normal termination of the autofocus operation. In the first embodiment, the notification signal based on the first detection signal and the notification signal based on the second detection signal are output, but in the present modified example, only the notification signal based on the second detection signal is output. In the present modified example, when both a sharpness change that leads to the occurrence of imaging obstruction and an abnormality in the autofocus operation are detected, and the occurrence of imaging obstruction is highly likely, the notification signal is output. Therefore, the reliability of a notification of the imaging obstruction state by outputting the notification signal can be enhanced.

### Second Embodiment

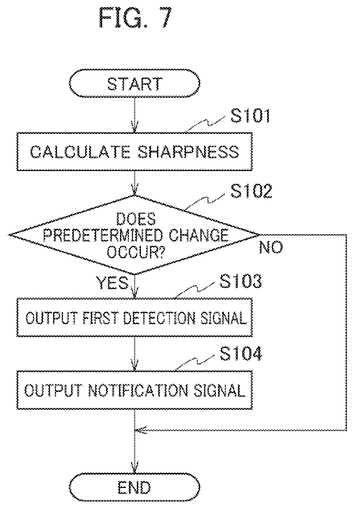

In the imaging obstruction detection apparatus 100 of the second embodiment, step S105 and subsequent steps in FIG. 4 performed in the imaging obstruction detection apparatus 100 of the first embodiment are omitted, as shown in the flowchart of FIG. 7. In the present embodiment, after outputting the first detection signal and the notification signal of imaging obstruction based on sharpness (steps S103 and S104), the series of steps is terminated. In the imaging obstruction detection apparatus 100 of the second embodiment, when a predetermined change with respect to the reference sharpness occurs in the sharpness, a sharpness change that leads to the occurrence of imaging obstruction can be detected, and accurate detection of imaging obstruction can be achieved. In the imaging obstruction detection apparatus 100 of the second embodiment, when the autofocus processing unit 312 performs contrast autofocus processing, the sharpness of the captured image calculated by the autofocus processing unit 312 for the autofocus operation can be diverted. The sharpness of the diverted captured image can be used to detect imaging obstruction of the camera unit 20. In this case, in the imaging obstruction detection apparatus 100 of the second embodiment, it is not necessary to perform new image processing for obstruction detection, the processing procedure can be simplified, and a need to provide a new image processing block can be eliminated.

### Third Embodiment

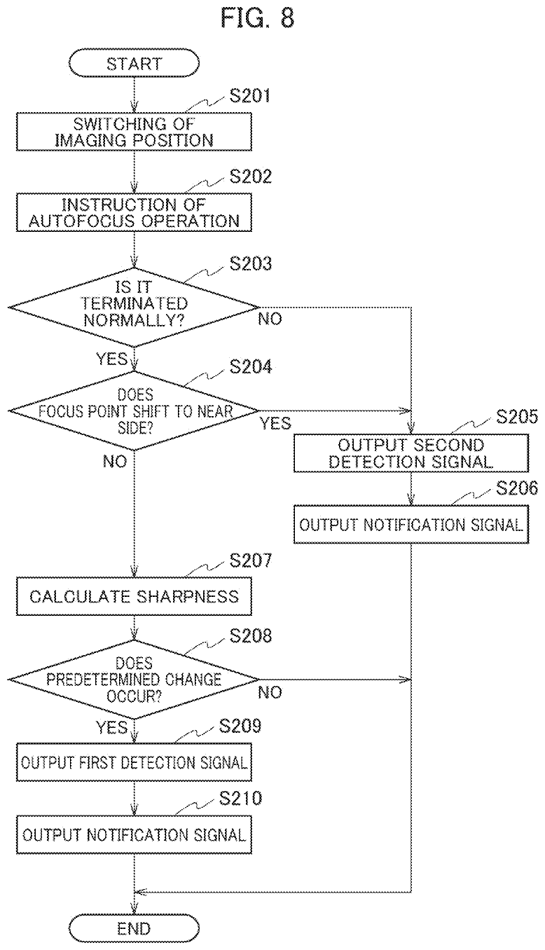

In the imaging obstruction detection apparatus 100 of the third embodiment, as shown in the flowchart of FIG. 8, when the imaging position of the camera unit 20 switches to one of the preset positions 72 to 74 (step S201), processing starts. In the started processing, the detection unit 314 instructs the autofocus processing unit 312 to execute the autofocus operation of the camera unit 20 (step S202). The detection unit 314 confirms whether the autofocus operation executed by the autofocus processing unit 312 terminates normally (step S203). If the autofocus operation does not terminate normally and terminates abnormally (NO in step S203), the process proceeds to step S205, which will be described later. If the autofocus operation terminates normally (YES in step S203), the detection unit 314 confirms whether the focus point of the lens block 21 after the autofocus operation shifts from the reference focus position (step S204). A direction of shift to be confirmed may be the near side or the far side of the reference focus position, or may be limited to the near side. In step S204, the detection unit 314 confirms whether the focus point of the lens block 21 after the autofocus operation at each of the preset positions 72 to 74 as the imaging position deviates from the reference focus position.

If the focus point of the lens block 21 after the autofocus operation does not shift from the reference focus position (NO in step S204), the process proceeds to step S207 and subsequent steps, which will be described later. If the focus point after the autofocus operation shifts from the reference focus position (YES in step S204), the process proceeds to step S205. In step S205, the detection unit 314 outputs a second detection signal. The notification unit 315 outputs the notification signal that notifies, for example, that imaging obstruction is detected based on the focus point of the lens block 21, based on the second detection signal output by the detection unit 314 (step S206). After the notification unit 315 outputs the notification signal, the series of steps is terminated.

After step S207, the processing of steps S207 to S210 is executed. The processing performed in each of steps S207 to S210 is the same as the processing performed in steps S101 to S104 of FIG. 7 referred to in the explanation of the second embodiment. In step S207, the autofocus processing unit 312 or the detection unit 314 calculates the sharpness of the image in the image signal input from the imaging unit 24. In step S208, the detection unit 314 confirms whether a predetermined change with respect to the reference sharpness occurs in the calculated sharpness. If the predetermined change with respect to the reference sharpness does not occur in the calculated sharpness (NO in step S208), the series of steps is terminated. If the predetermined change with respect to the reference sharpness occurs in the calculated sharpness (YES in step S208), the detection unit 314 outputs the first detection signal (step S209). Based on the first detection signal output by the detection unit 314, the notification unit 315 outputs a notification signal (step S210). The notification signal may have a content that notifies that imaging obstruction is detected based on sharpness, for example. After the notification unit 315 outputs the notification signal, the series of steps is terminated.

The sharpness of the captured image by the camera unit 20 changes depending on whether the camera unit 20 is in an in-focus state or not. When the imaging position of the camera unit 20 switches to one of the preset positions 72 to 74, it is necessary to compare the sharpness of the captured image with the reference sharpness at the switched imaging position. In the imaging obstruction detection apparatus 100 of the third embodiment, when the imaging position of the camera unit 20 switches to one of the preset positions 72 to 74, the autofocus operation is executed. Based on the focus point of the lens block 21 after the autofocus operation, an occurrence of an abnormality in the autofocus operation that leads to the occurrence of imaging obstruction can be recognized in control with higher accuracy. Note that after the processing of the procedure of FIG. 8 is executed, until the imaging position of the camera unit 20 switches next, processing may be performed by any of the procedures of the first embodiment, the modified examples thereof, and the second embodiment described with reference to FIGS. 4 and 7, for example.

In the other embodiment and the modified examples thereof described above except the second embodiment, when the focus point of the lens block 21 deviates to the near side from the reference focus position after the autofocus operation, the occurrence of “imaging obstruction by obstruction” is notified to a user. Alternatively, when the autofocus operation does not terminate normally, the occurrence of “imaging obstruction based on not capturing the imaging target” is notified to a user. However, the user may be notified that some imaging obstruction occurs when the focus point of the lens block 21 deviates from the reference focus position, including when the focus point of the lens block 21 deviates to the far side from the reference focus position after the autofocus operation. Also, a different notification may be made for each of the cases: when the focus point of the lens block 21 deviates to the near side from the reference focus position, when the focus point deviates to the far side from the reference focus position, and when the autofocus operation terminates abnormally.

### Fourth Embodiment

The fourth embodiment is an embodiment for detecting imaging obstruction using a change in the autofocus position. In the present embodiment, the autofocus processing unit 312 performs autofocus processing that does not require image processing. The autofocus processing that does not require image processing may be, for example, phase difference autofocus processing or laser autofocus processing. In the present embodiment, a case where phase difference autofocus is used will be described.

In the phase difference autofocus processing, the autofocus processing unit 312 detects a phase difference between two images formed on the imaging unit 24 by light that has passed through the lens block 21. The two images for detecting the phase difference may be two images formed on separate imaging elements of the imaging unit 24 by bifurcating the light that has passed through the lens block 21 into two by a beam splitter. The two images for detecting the phase difference may be two images formed on an AF (Auto Focus) sensor arranged on a single imaging element of the imaging unit 24 by dividing the light that has passed through the lens block 21 into two by a separator lens (not illustrated). In the latter case, the phase difference between the two images is an image plane phase difference obtained from an output of the AF sensor. The autofocus processing unit 312 detects pixel shift of the two images based on the detected phase difference, and detects a shift amount and a shift direction of the focus point of the lens block 21 from the detected pixel shift.

The autofocus processing unit 312 executes the autofocus operation of the camera unit 20 based on the detected shift amount of the focus point. In the autofocus operation, the autofocus processing unit 312 moves the respective lenses of the lens block 21 in their lens optical axis directions by the zoom adjustment unit 22 and the focus adjustment unit 23 so as to eliminate the shift amount of the focus point. The autofocus processing unit 312 stops the movement of the respective lenses at positions where the shift amount of the focus point is eliminated, and completes the autofocus operation of the camera unit 20. The focus point of the lens block 21 when the autofocus operation is completed, is at a position of an imaging target that is in focus in capturing at the imaging position.

The autofocus processing unit 312 normally terminates the autofocus operation when the autofocus operation is completed within a predetermined time from the start of the autofocus operation. If the autofocus operation is not completed within the predetermined time from the start, the autofocus processing unit 312 abnormally terminates the autofocus operation.

The focus position determination unit 313 determines the focus position of the lens block 21 when the autofocus operation is normally terminated, from the movement amounts of the respective lenses of the lens block 21. The focus position determination unit 313 may store the determined focus position of the lens block 21 as the focus position after the autofocus operation in, for example, the memory of the microcontroller 310. The focus position determination unit 313 can determine whether the determined focus point of the lens block 21 deviates from the reference focus position at each of the preset positions 72 to 74, which is the imaging position during the autofocus operation, to either near or far. The focus position determination unit 313 may determine whether the focus point of the lens block 21 after the autofocus operation deviates from the reference focus position using the upper limit value and the lower limit value of the parameter “Focus Range” of each of the preset positions 72 to 74 in FIG. 3 as threshold values. The focus position determination unit 313 may determine whether the focus point of the lens block 21 that deviates from the reference focus position at each of the preset positions 72 to 74 deviates to the near or far side.

The detection unit 314 outputs the second detection signal indicating detection of imaging obstruction when the focus position determination unit 313 determines that the focus point of the lens block 21 after the autofocus operation when the imaging position switches to each of the preset positions 72 to 74, deviates from the reference focus position. The second detection signal is also simply called a detection signal. The detection unit 314 may output the detection signal based on a determination result of whether the position deviating from the reference focus position at each of the preset positions 72 to 74 is a position closer to the lens block 21 or farther from the lens block 21 than the reference focus position.

The detection unit 314 may be configured to output the second detection signal only when the focus position determination unit 313 determines that the focus point of the lens block 21 after the autofocus operation deviates to the near side closer to the camera unit 20 than the reference focus position, for example. The focal length of the lens block 21 whose focus point deviates to the near side from the reference focus position after the autofocus operation at each of the preset positions 72 to 74 is in a state in which it is shorter than the lower limit value of the parameter “Focus Range” of each of the preset positions 72 to 74. The detection unit 314 regards this state as a state in which an obstruction that obstructs the imaging of one of the gates 62 to 64 appears between the one of the gates 62 to 64 that should originally be captured when capturing one of the preset positions 72 to 74 and the camera unit 20. The position deviating to the near side from the reference focus position may be determined, for example, by whether the focus point is at a position closer to the camera unit 20 than the adjustable range of the focus point corresponding to the registered parameter “Zoom” of each of the preset positions 72 to 74 that is the imaging position. If the focus point of the lens block 21 is within the adjustable range, it can be considered that the focus point is substantially at a position within the range of the parameter “Focus Range” of each of the preset positions 72 to 74 that is the imaging position.

The detection unit 314 may be configured to output the second detection signal only when the autofocus operation terminates abnormally, for example, when the focus point of the lens block 21 after the autofocus operation deviates from the reference focus position of the imaging target during autofocus. The detection unit 314 may be configured to output a different detection signal for each of cases: when the focus point of the lens block 21 after the autofocus operation deviates from the reference focus position, when the focus point of the lens block 21 after the autofocus operation deviates to the near side from the reference focus position, and when the autofocus operation terminates abnormally.

The notification unit 315 outputs the notification signal that notifies a user of a state in which imaging by the camera unit 20 at each of the preset positions 72 to 74 is obstructed, based on the detection signal output by the detection unit 314.

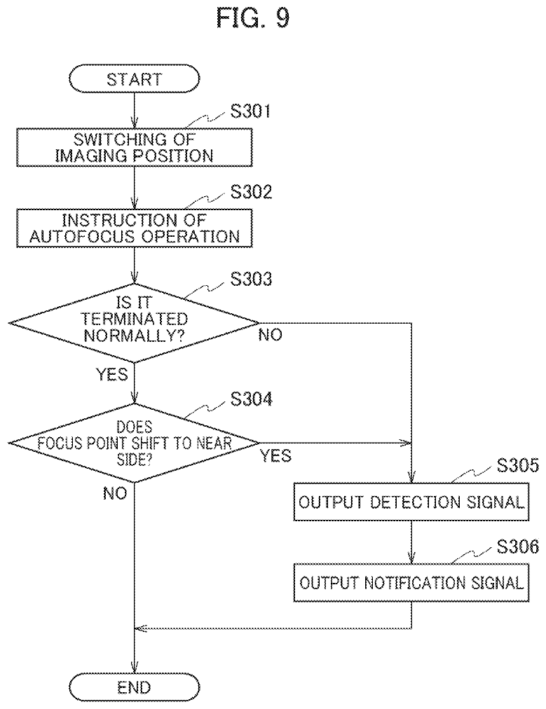

Next, an example of a processing procedure executed in the imaging obstruction detection apparatus 100 to detect a state in which imaging at each of the preset positions 72 to 74 by the camera unit 20 is obstructed in the surveillance camera apparatus 10 of the present embodiment will be described with reference to FIG. 9. The imaging obstruction detection apparatus 100 repeatedly executes the processing procedure shown in FIG. 9 during operation of the surveillance camera apparatus 10. The processing procedure of FIG. 9 is an example of detecting imaging obstruction when the focus point of the lens block 21 after the autofocus operation shifts to the near side from the reference focus position.

First, when the imaging position of the camera unit 20 switches to one of the preset positions 72 to 74 (step S301), the detection unit 314 instructs the autofocus processing unit 312 to execute the autofocus operation of the camera unit 20 (step S302). The detection unit 314 confirms whether the autofocus operation executed by the autofocus processing unit 312 terminates normally (step S303). If the autofocus operation does not terminate normally and terminates abnormally (NO in step S303), the process proceeds to step S305, which will be described later. If the autofocus operation terminates normally (YES in step S303), the detection unit 314 confirms whether the focus point of the lens block 21 determined by the focus position determination unit 313 after the autofocus operation shifts to the near side (step S304). The detection unit 314 confirms whether the focus point of the lens block 21 after the autofocus operation shifts to the near side based on the reference focus position at each of the preset positions 72 to 74 corresponding to the imaging position of the camera unit 20.

The detection unit 314 may confirm that the focus point shifts to the near side from the reference focus position when, for example, the focal length of the lens block 21 after the autofocus operation is shorter than the lower limit value of the registered parameter “Focus Range” of each of the preset positions 72 to 74 which is the imaging position. The detection unit 314 may confirm that the focus point shifts to the near side from the reference focus position when the focal length of the lens block 21 is shorter than the lower limit value of the adjustable range of the focus point corresponding to the registered parameter “Zoom” of each the preset positions 72 to 74 which is the imaging position.

If the focus point of the lens block 21 after the autofocus operation does not shift to the near side from the reference focus position (NO in step S304), the series of steps is terminated. If the focus point after the autofocus operation shifts to the near side from the reference focus position (YES in step S304), the process proceeds to step S305.

In step S305, the detection unit 314 outputs the detection signal. The notification unit 315 outputs the notification signal based on the detection signal output by the detection unit 314 (step S306). After the notification unit 315 outputs the notification signal, the series of steps is terminated.

FIG. 5 shows an example of each relationship between a pattern of imaging obstruction to be assumed in the surveillance camera apparatus 10 and an event occurring in the pattern. As scenes each in which imaging at each of the preset positions 72 to 74 is obstructed in the surveillance camera apparatus 10, scenes as shown in the leftmost column of FIG. 5 can be mentioned, for example.

Among these, in the scene “obstruction”, as shown in the rightmost column of FIG. 5, the focus point of the lens block 21 is on the near side from the reference focus position at each of the preset positions 72 to 74. The near side means the camera unit 20 side from the reference focus position. In the scene “subject moved far away,” the focus point of the lens block 21 after the autofocus operation is on the far side from the reference focus position. The far side means a side opposite to the camera unit 20 side from the reference focus position.

In each of the scenes “lens half painted with spray” and “strong light hitting half of lens”, the focus point of the lens block 21 after the autofocus operation is on the near side or the far side from the reference focus position at each of the preset positions 72 to 74. In the scene “camera direction changes,” the focus point of the lens block 21 after the autofocus operation is on the near side or the far side from the reference focus position at each of the preset positions 72 to 74. Alternatively, the autofocus operation may terminate abnormally because a focusable imaging target cannot be identified, and the focus point of the lens block 21 after the autofocus operation may become unpredictable. In each of the scenes “covered with cloth”, “lens fully painted with spray” and “strong light hitting entire lens”, the autofocus operation may terminate abnormally, and the focus point of the lens block 21 after the autofocus operation may become unpredictable.

The scene “obstruction” means an object that exists between the reference focus position at each of the preset positions 72 to 74 and the camera unit 20 and blocks the field of view of the lens block 21 in front of the reference focus position. FIG. 6 illustrates a state in which a part of the gate 64 is blocked from the viewing range of the lens block 21 by the vehicle 80 in the distribution warehouse 60 when the imaging position is the preset position 74. In this case, the vehicle 80 corresponds to an “obstruction” that obstructs imaging of the gate 64 by the camera unit 20.

When imaging of each of imaging targets such as the gates 62 to 64 at the preset positions 72 to 74 is obstructed, it is assumed that the focus point of the lens block 21 after the autofocus operation deviates from the reference focus position. For example, in a scene where imaging of the imaging target is obstructed by an “obstruction”, it is assumed that the focus point of the lens block 21 after the autofocus operation moves to the camera unit 20 side from the reference focus position, as shown in FIG. 5.

In the present embodiment, the detection unit 314 detects the focus point of the lens block 21 after the autofocus operation when the imaging position of the camera unit 20 switches to one of the preset positions 72 to 74. The autofocus operation is substantially performed as an operation that substitutes for position detection of the imaging target to confirm through the focus point of the lens block 21 whether the imaging target by the camera unit 20 changes to an object on the camera unit 20 side from one of the gates 62 to 64. In the autofocus operation, when the focus point of the lens block 21 moves to the near side from the registered reference focus position, the lens block 21 is focused on an object positioned in front of the one of the gates 62 to 64 at the one of the preset positions 72 to 74. In this case, it is estimated that a state exists in which imaging of the one of the gates 62 to 64 that should originally be imaged is obstructed, and the one of the gates 62 to 64 is not appropriately imaged by the camera unit 20.

When the focus point of the lens block 21 moves to a position deviated from the reference focus position in the autofocus operation, the detection unit 314 and the notification unit 315 output the second detection signal and the notification signal, respectively. With the detection signal, the imaging obstruction detection apparatus 100 can recognize the occurrence of imaging obstruction in control. With the notification signal, the imaging obstruction detection apparatus 100 can notify a user of the occurrence of imaging obstruction.

In the present embodiment, when the focus point of the lens block 21 moves to the near side from the reference focus position after the autofocus operation at each of the preset positions 72 to 74, the focus point of the lens block 21 is focused on an object in front of each of the gates 62 to 64. In this case, it is assumed that there is a state in which an “obstruction” exists at a position on the camera unit 20 side from each of the gates 62 to 64, which is the imaging targets. When the autofocus operation does not terminate normally in the autofocus operation, it is estimated that the lens block 21 is in a state in which it does not capture an imaging target to be focused. In these states, it is considered that the field of view of the camera unit 20 is blocked in front of the reference focus position or near the lens block 21.

When the focus point of the lens block 21 moves to a position deviated to the near side from the reference focus position in the autofocus operation, the detection unit 314 and the notification unit 315 output a detection signal and a notification signal for imaging obstruction by an “obstruction”. With the detection signal, the imaging obstruction detection apparatus 100 can recognize the occurrence of imaging obstruction by the “obstruction” in control. With the notification signal, the imaging obstruction detection apparatus 100 can notify a user of the occurrence of imaging obstruction by the “obstruction.”

In the present embodiment, when the autofocus operation at each of the preset positions 72 to 74 does not terminate normally, the detection unit 314 and the notification unit 315 output the second detection signal and the notification signal, respectively. With the detection signal, the imaging obstruction detection apparatus 100 can recognize in control the occurrence of imaging obstruction based on the lens block 21 not capturing an imaging target to be focused. With the notification signal, the imaging obstruction detection apparatus 100 can notify a user of the occurrence of imaging obstruction based on the lens block 21 not capturing an imaging target to be focused.

In the present embodiment, when the focus point of the lens block 21 deviates to the near side from the reference focus position after the autofocus operation, the occurrence of “imaging obstruction by obstruction” is notified to a user. Alternatively, when the autofocus operation does not terminate normally, the occurrence of “imaging obstruction based on not capturing the imaging target” is notified to a user. However, the user may be notified that some imaging obstruction occurs when the focus point of the lens block 21 deviates from the reference focus position, including when the focus point of the lens block 21 deviates to the far side from the reference focus position after the autofocus operation. Also, a different notification may be made for each of cases: when the focus point of the lens block 21 deviates to the near side from the reference focus position, when the focus point deviates to the far side from the reference focus position, and when the autofocus operation terminated abnormally.

In the present embodiment, since the autofocus operation of the camera unit 20 is performed by phase difference autofocus processing that does not require image processing, the detection unit 314 can quickly detect the occurrence of imaging obstruction from the relationship between the focus point after the autofocus operation and the reference focus position. In the imaging obstruction detection apparatus 100 of the present embodiment, the time required for the detection unit 314 to detect imaging obstruction can be shortened.

In the above-described embodiments and modified examples, the imaging obstruction detection apparatus 100 is provided in the controller 30, but the imaging obstruction detection apparatus according to the present embodiment may be provided in a part other than the controller 30, such as a computer that communicates with the controller 30 via a network.

Although the embodiments and modified examples have been described above, modifications or variations of the embodiments can be made based on the above disclosure. All components in the above embodiments and modified examples, and all features described in the claims, may be individually extracted and combined as long as they do not contradict each other.

According to the present embodiment, it is possible to provide an imaging obstruction detection apparatus and an imaging obstruction detection method capable of accurately detecting obstruction to imaging by a surveillance camera.

What is claimed is

1. An imaging obstruction detection apparatus that detects imaging obstruction of a camera, comprising:
a detection unit configured to output a detection signal indicating detection of an abnormality in an autofocus operation when sharpness in a captured image by the camera at a preset position changes by a predetermined amount or more from a reference sharpness and when a focus point after the autofocus operation of the camera shifts to a near side from a reference focus position at the preset position.

2. The imaging obstruction detection apparatus according to claim 1, wherein
the detection unit is configured to output a detection signal indicating detection of an abnormality in an autofocus operation when the autofocus operation of the camera is not completed within a predetermined time from a start of the autofocus operation to be abnormally terminated.

3. The imaging obstruction detection apparatus according to claim 1, further comprising a notification unit configured to output a notification signal associated with the abnormality in the autofocus operation based on the detection signal.

4. The imaging obstruction detection apparatus according to claim 2, further comprising a notification unit configured to output a notification signal associated with the abnormality in the autofocus operation based on the detection signal.

5. An imaging obstruction detection method in an imaging obstruction detection apparatus that detects imaging obstruction of a camera, comprising:
outputting a detection signal indicating detection of an abnormality in an autofocus operation when sharpness in a captured image by the camera at a preset position changes by a predetermined amount or more from a reference sharpness and when a focus point after the autofocus operation of the camera shifts to a near side from a reference focus position at the preset position.

6. The imaging obstruction detection method according to claim 5, further comprising outputting a detection signal indicating detection of an abnormality in an autofocus operation when the autofocus operation of the camera is not completed within a predetermined time from a start of the autofocus operation to be abnormally terminated.

7. The imaging obstruction detection method according to claim 5, further comprising outputting a notification signal associated with the abnormality in the autofocus operation based on the detection signal.

8. The imaging obstruction detection method according to claim 6, further comprising outputting a notification signal associated with the abnormality in the autofocus operation based on the detection signal.
